(19) United States
(12) Patent Application Publication
(10) Pub. No.: US 2009/0178582 A1
(43) Pub. Date: Jul. 16, 2009

(54) PRINTING APPARATUS

(76) Inventor: Massimiliano Dal Pont, Selargius (IT)

Correspondence Address: LAUBSCHER & LAUBSCHER, P.C., 1160 SPA ROAD, SUITE 2B, ANNAPOLIS, MD, 21403, US

(21) Appl. No.: 12/297,667

(22) PCT Filed: Apr. 19, 2007
(86) PCT No.: PCT/IB2007/001014

§ 371 Date: Jan. 20, 2009

(30) Foreign Application Priority Data
Apr. 19, 2006 (IT) MO2006A000127

(51) Int. Cl. B05C 17/08

(52) U.S. Cl. 101/126

(57) ABSTRACT

A printing apparatus for printing discrete sheets includes a plurality of offset printing units arranged in sequence along an advancing direction of the discrete sheets, a screen-printing unit for supporting the discrete sheets, and a device for applying a flowable material to the discrete sheets. Each screen-printing unit includes a shifting device for shifting the applying device between an operating position in which the applying device interacts with the discrete sheets and a disengagement position in which the applying device is distanced from the screen printing supporting device. The printing apparatus also comprises a lamination unit for applying a film of plastic material to the discrete sheets.

The invention concerns a printing apparatus for offset printing on discrete sheets, in particular for use in publishing, commerce, advertising or the arts.

The prior art comprises printing machines for use in publishing, advertising or the arts, provided with a plurality of offset printing units arranged sequentially.

These machines are provided with elements that supply the first printing unit with the loose sheets to be printed, and with conveyor rollers which convey the sheets to the subsequent printing units. The sheets thus conveyed first encounter the offset printing units predisposed to apply an ink using the offset printing process. Downstream of the offset printing units a flexographic printing unit is provided, and lastly a dryer.

Each of the offset printing units deposits on the sheet only one ink, that is to say only one colour; a layer of colour is deposited on the sheet at each unit and the various layers of colour are thus applied one over the other to form a printed motif. Between one unit and the next and before the flexographic printing unit, UV/IR drying devices can be provided to facilitate drying the newly-deposited ink.

The flexographic printing unit deposits inks on the sheet already bearing the printed motif in order to provide the sheet with particular qualities, for example, transparent varnishes used to obtain a glossy or matt effect.

The printed sheets are then conveyed inside the dryer which is provided with a tunnel where the sheets pass under various drying devices arranged to dry the inks completely. The drying devices can for example be hot air/IR knives, or UV dryers.

Once the sheets have left the dryer the printing process is complete and the printed sheets are ready for removal from the printing machine.

A drawback of the offset printing machines for sheets is that the flexographic printing unit is unable to provide a high quality printing process. In fact the transparent varnish is deposited on the sheet irregularly and there are depressions which give the surface of the printed sheets a visible effect of undulation, which is unsuitable for high quality prints.

A further drawback of known offset printing machines is that the flexographic printing unit is incapable of printing thick layers of transparent varnish, useful in a multitude of applications. For example such layers are useful for increasing the chemical/physical resistance of printed sheets when sheets for advertising are printed in order to be displayed outdoors.

Plasticizing machines are known which cover such printed sheets with layers of plastic material.

For protection or to prevent forgery, such machines apply a film of transparent plastic material to the surface of a sheet previously printed by a machine of a known type. Coating the printed sheet with a layer of plastic material increases the chemical/physical resistance of the sheet or makes it possible to obtain a security layer of plastic material to prevent the forging of signatures or serial numbers that may be present on the sheet.

A drawback of known plasticizing machines is that they are generally situated on premises other than those in which the printed sheets are produced.

It thus becomes necessary to make use of dedicated human resources or automated conveyor means to transfer the printed sheets to the plasticizing machine, consequently increasing production times and costs.

Furthermore, during transfer to the plasticizing machine the printed sheets can be subject to alteration. For example, signatures or serial numbers can be tampered with, or accidents can happen during transfer which might ruin the motif printed on the sheets.

An object of the invention is to improve known printing machines provided with a plurality of printing units arranged sequentially.

A further object is to improve the quality of the printing process for publishing, commercial, advertising or artistic use, in particular by reducing the unevenness that known printing machines produce in the layers of transparent varnish.

A still further object is to succeed in printing thicker layers of transparent varnish with offset printing machines.

A further object is to make durable printing machines, in which the printing devices are protected to prevent excessive wear or damage to them.

Another object is to provide printing apparatuses for printing onto discrete sheets that enable high printing precision to be obtained, in particular preventing undesired moving between the discrete sheets and the corresponding supporting means.

A further object is to improve the systems in which a film of plastic material is applied to a sheet.

A further object is to reduce times and costs of production for printed sheets coated with a film of transparent plastic material.

A further object is to prevent printed sheets from being tampered with before a plasticizing machine deposits a protective layer of transparent plastic material upon them.

In a first aspect of the invention, there is provided a printing apparatus for printing discrete sheets, comprising a plurality of offset printing units arranged in sequence along an advancing direction of said discrete sheets, at least one screen-printing unit including supporting means for supporting said discrete sheets and applying means for applying a flowable material to said discrete sheets, said at least one screen-printing unit comprising a shifting device for shifting said applying means between an operating position in which said applying means interacts with said discrete sheets, and a disengagement position in which said applying means is distanced from said supporting means.

Thanks to the first aspect of the invention a better quality printing process can be obtained. In fact the screen-printing unit can deposit a flowable material such as an ink, for example a transparent varnish, on the sheet more uniformly than the flexographic printing unit used in prior art machines. The screen-printing unit can print a substantially constant layer of colour or transparent varnish on the sheet. Thus, no undesired undulations are visible on the surface of the sheet, and prints have a high-quality surface finish which is particularly appreciated for use in publishing, commercial, advertising, or for artistic use.

Furthermore, the screen-printing unit makes it possible to print a much thicker layer of colour or transparent varnish on the sheet than was possible with prior-art flexographic printing units. In this way it is possible to increase the chemical/physical resistance of the printed sheet and to obtain an extremely versatile printing apparatus.

Owing to the shifting device, it is possible to shift the applying means from the supporting means after the applying means has applied the flowable material to the sheet to be printed. In this way, possible accessory devices present on the supporting means, for example gripping devices, are prevented from coming into contact with the applying means and damaging it.

In a second aspect of the invention, there is provided a printing apparatus for printing discrete sheets, comprising a plurality of offset printing units arranged in sequence along an advancing direction of said discrete sheets and at least one screen-printing unit, said at least one screen-printing unit comprising supporting means for supporting said discrete sheets, there being provided sucking means distributed along a significant angular extent of a supporting cylinder of said supporting means, for maintaining said discrete sheets adhering to said supporting cylinder.

The sucking means enables adhesion of the sheet to an external surface of the supporting cylinder to be improved, preventing creases or undulations to be formed or air bubbles remaining trapped between the sheet and the surface of the supporting cylinder.

In this way printing quality is improved.

In a third aspect of the invention is provided a printing apparatus for printing discrete sheets, comprising a plurality of offset printing units arranged sequentially along an advancing direction of said discrete sheets, characterised by the fact that said printing apparatus comprises a plasticizing unit for applying a film of plastic material to the said discrete sheets.

Thanks to this aspect of the invention it is thus possible to coat the printed sheet with a film of plastic material immediately after the printing process has taken place. In this way, there is no longer any need to transfer the printed sheets to a plasticizing machine because the plasticizing unit is comprised within the printing apparatus. This reduces production times and costs.

It is further possible to use a film from which obtaining portions having desired dimensions.

Further, an extremely short time elapses between the possible printing of signatures or serial numbers on the sheet using the offset printing units and the application of the film of plastic material onto the same sheet. During this lapse of time the sheet remains within the printing apparatus. This considerably reduces any possibility of the signatures or serial numbers being tampered with or accidents taking place to ruin the printed motif.

The invention can be better understood and actuated with reference to the attached drawings, which illustrate some non-limiting examples of actuation in which:

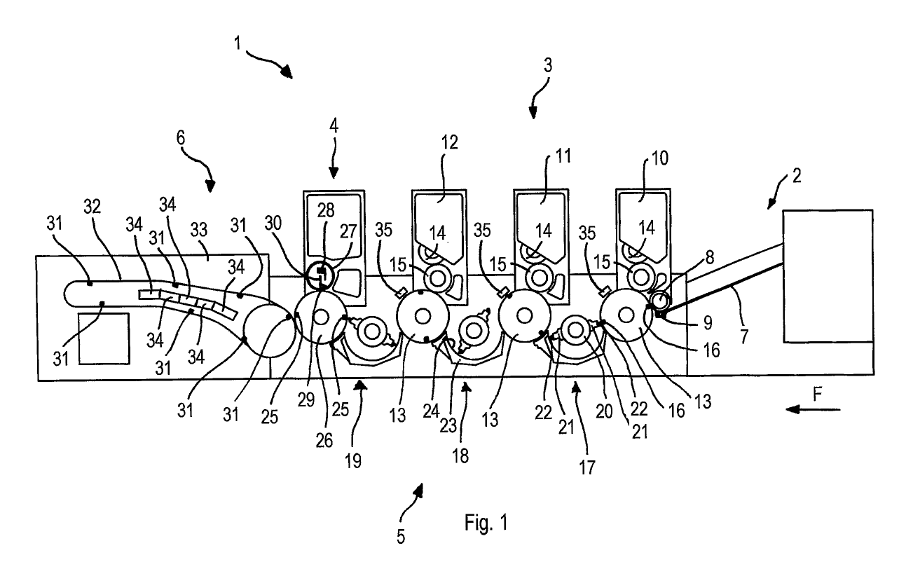

FIG. 1 is a schematic side view of a printing apparatus with three offset printing units and a screen-printing unit for discrete sheets;

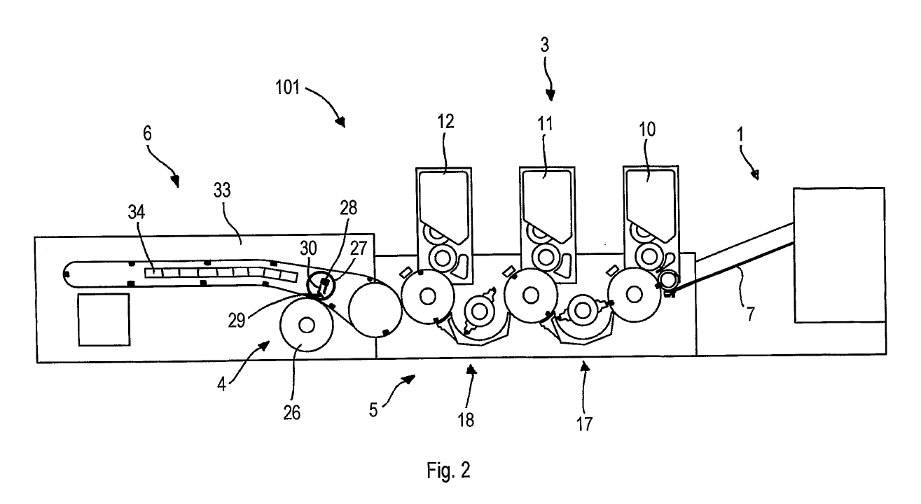

FIG. 2 is a schematic side view of a printing apparatus with three offset printing units and a screen-printing unit arranged within a drying tunnel;

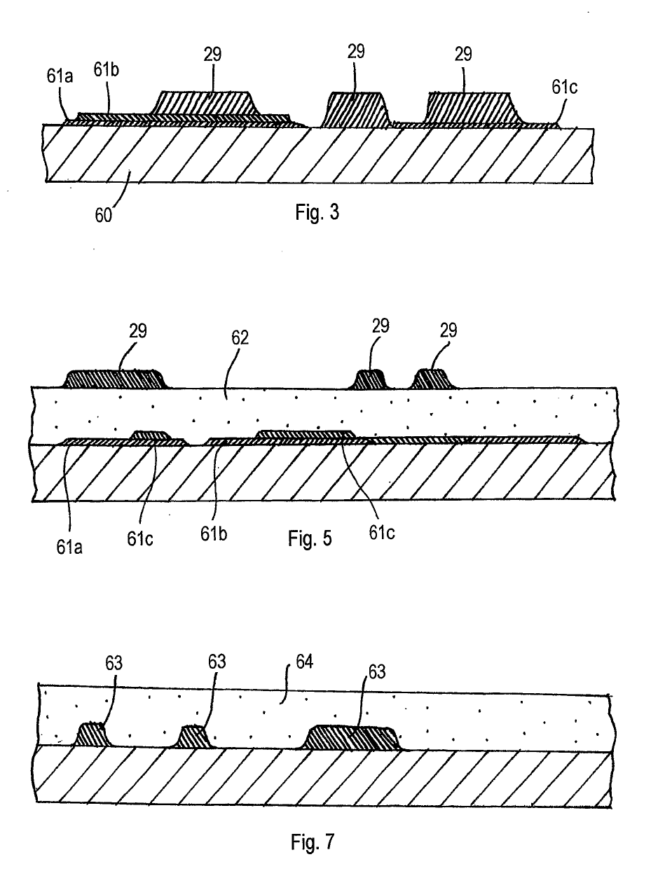

FIG. 3 is an enlarged section view of a sheet printed by an apparatus of the type shown in FIG. 1 or 2;

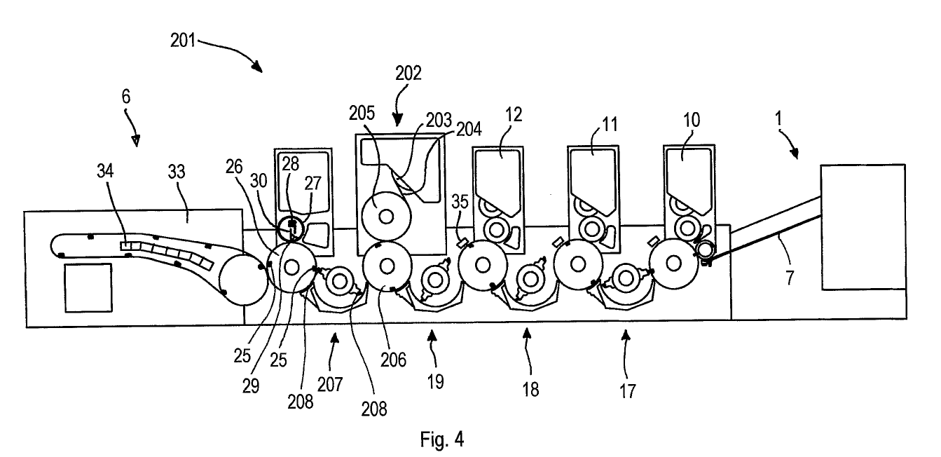

FIG. 4 is a schematic side view of a printing apparatus with three offset printing units, a plasticizing unit and a screen-printing unit for discrete sheets;

FIG. 5 is an enlarged section view of a sheet printed by a apparatus of the type shown in FIG. 4;

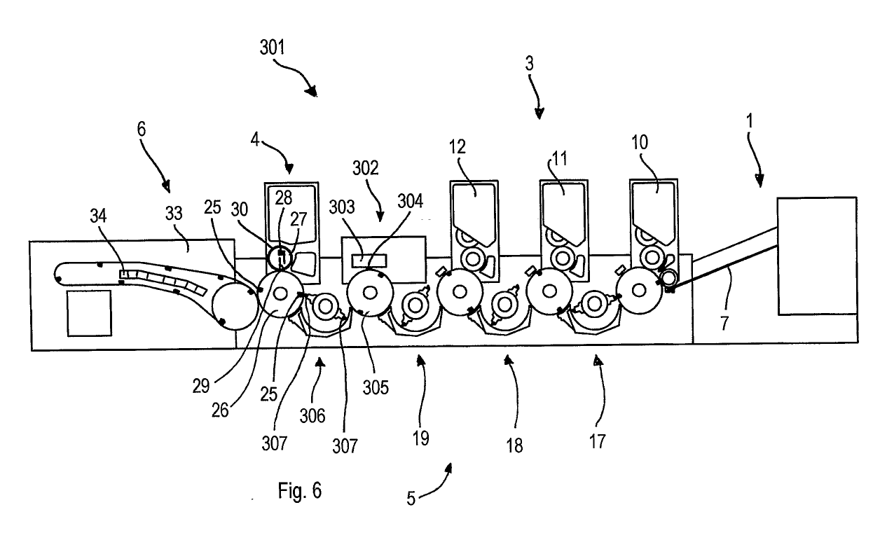

FIG. 6 is a schematic side view of a printing apparatus with three offset printing units, an ink jet unit and a screen-printing unit for discrete sheets;

FIG. 7 is an enlarged section view of a sheet printed with an apparatus of the type shown in FIG. 6.

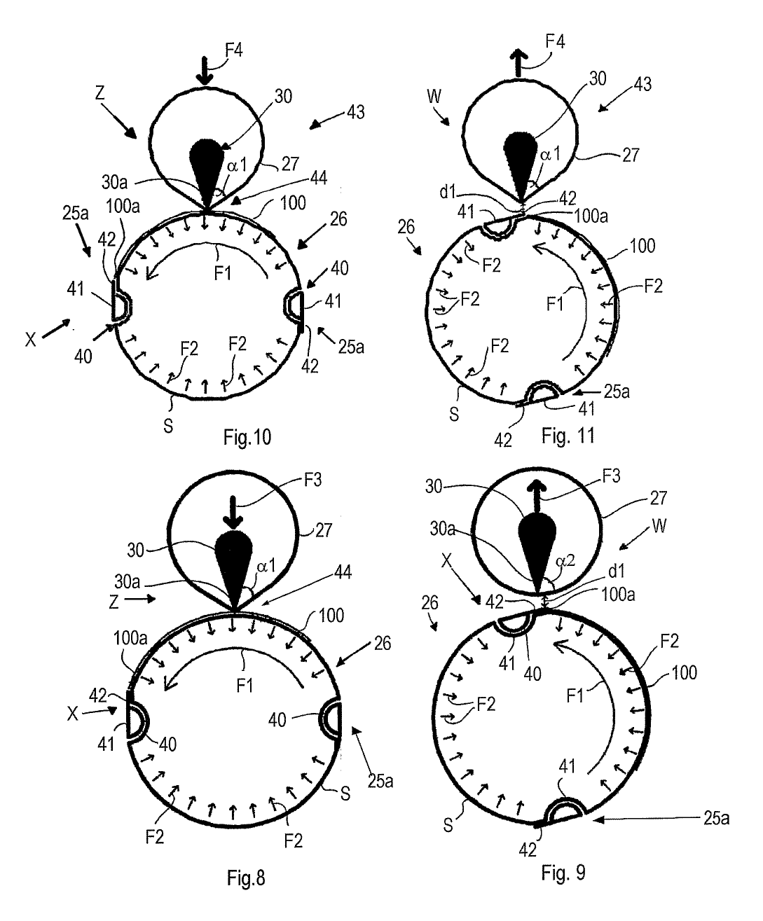

FIG. 8 is a schematic view of a screen-printing unit provided with a shifting device in an operating position;

FIG. 9 is a view of the printing unit in FIG. 8, in a disengagement position;

FIG. 10 is a view like the one in FIG. 8, showing a screen-printing unit according to an alternative embodiment;

FIG. 11 is a view of the printing unit in FIG. 10, in a disengagement position;

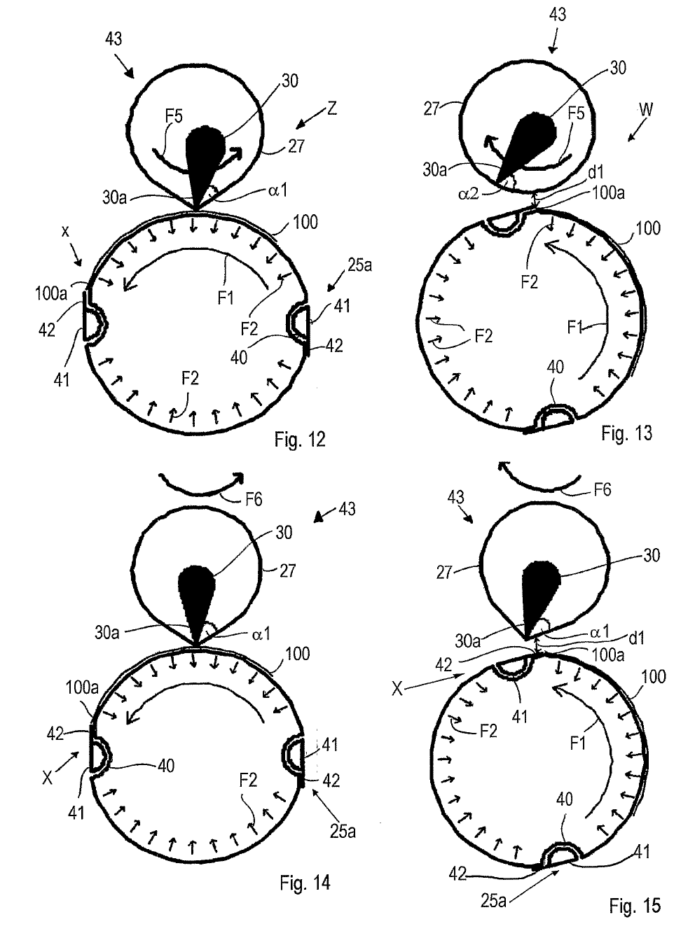

FIG. 12 is a view like the one in FIG. 8, showing a screen-printing unit according to a further alternative embodiment;

FIG. 13 is a view of the printing unit in FIG. 12, in a disengagement position;

FIG. 14 is a view like the one in FIG. 8, showing a screen-printing unit according to another alternative embodiment;

FIG. 15 is a view of the printing unit in FIG. 14, in a disengagement position;

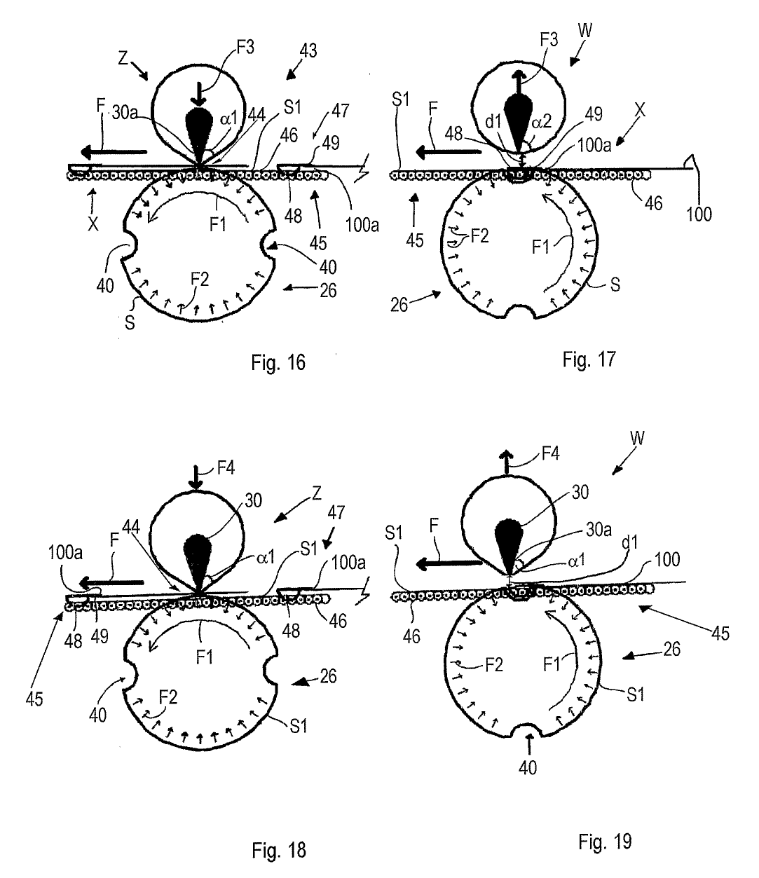

FIGS. 16-23 are similar views to FIGS. 8-15, that show printing units provided with moving means according to alternative embodiments;

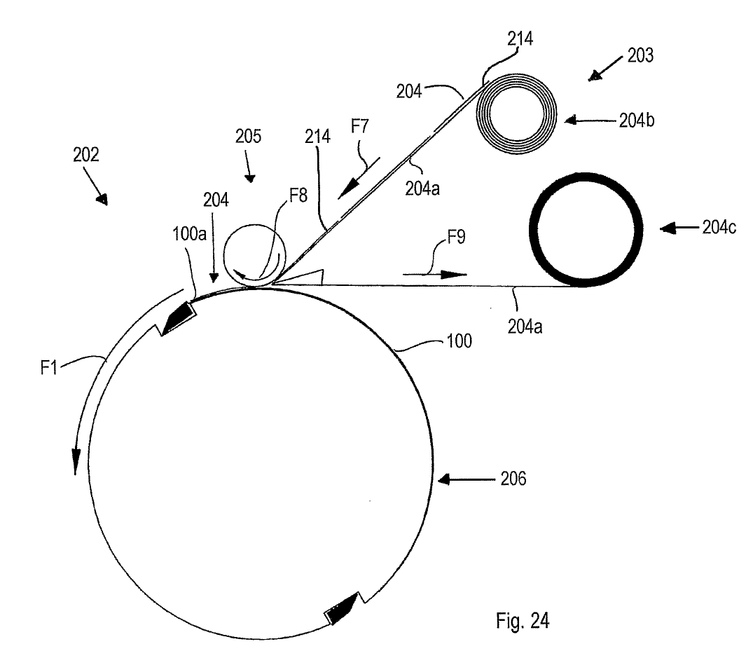

FIG. 24 is an enlarged schematic view of a plasticizing unit of a printing apparatus.

With reference to FIG. 1 a printing apparatus 1 is shown which comprises feeding means 2 arranged to continuously feed the printing apparatus 1 with a plurality of discrete sheets to be printed, offset printing means 3, a screen-printing unit 4, conveying means 5 arranged for continuously conveying the sheets from one unit to another, and drying means 6.

The sheets to be printed are fed into the printing apparatus 1 in piles of sheets not illustrated in FIG. 1. The feeding means 2 moves the sheets in order to position them one after the other on a feeding table 7. The sheets are then conveyed onto the feeding table 7 to the offset printing means 3.

In the illustrated example, the offset printing means 3 comprise a first offset printing unit 10, a second offset printing unit 11 and a third offset printing unit 12 arranged sequentially along an advancing direction F. It is however possible to provide a number of offset printing units other than three, and in particular greater than three, depending on the type of motif to be printed.

At the end of the feeding table, is disposed a feeding roller 8 provided with gripping elements 9, which grip an edge of the sheet and convey the sheet to load it onto a supporting roller 13 of the first offset printing unit 3. The gripping elements 9 release the sheet when it has been blocked on the supporting roller 13 by means of elements that will be described herein below.

Each of the offset printing units 10, 11 and 12 uses an offset printing process to deposit an ink of a respective colour on the sheet; the various inks deposited on the sheet at each of the offset printing units 10, 11 and 12 are superimposed one over the other so as to form a printed motif.

Each offset printing unit 10, 11 and 12 comprises an applying cylinder 14, the surface of which is covered by a printing plate, not shown in the Figure. On the printing plate there are ink-repellent areas and printing areas upon which the ink can be deposited. As it rotates, the applying cylinder is in contact with an inking cylinder, not shown in the figure, predisposed to deposit the ink on the printing plate. Because of the affinity between the printing areas and the ink, the latter is deposited only on the printing area, while the repellent areas remain substantially clean. The printing areas on the plate are so arranged as to reproduce a part of the motif to be printed, that is, that part of the motif obtained with the colour that the printing unit is predisposed to apply. With every rotation of the applying cylinder 14, the printing areas receive ink from the inking cylinder and subsequently release it onto a transferring roller 15, delimited by a rubber surface and able to transfer the ink to the sheet.

Each offset printing unit 10, 11 and 12 further comprises the supporting roller 13 predisposed to convey the sheet through the corresponding offset printing unit and to provide a support to the sheet during the printing process. Each supporting roller 13 is provided with gripping devices 16, provided with pliers not shown in the Figure, arranged to grip the edge of the sheet when the latter is brought in proximity of the supporting roller 13 and released by the feeding roller 8, upon entry into the first offset printing unit 10, or by the conveying means 5, upon entry into the second offset printing unit 11 and the third offset printing unit 12.

During functioning, the transferring roller 15, which has received the ink from the applying cylinder 14, in turn deposits the ink on the sheet conveyed and supported by the supporting roller 13 and blocked by the gripping devices 16. When it has been inked, the sheet is released by the supporting roller 13 to the conveying means 5.

The conveying means 5 comprises a first conveying device 17, a second conveying device 18 and a third conveying device 19, arranged sequentially along the advancing direction F to convey the sheets from one printing unit to the next.

Each conveying device 17, 18 and 19 comprises a conveying roller 20; rotating about its own axis, upon which are mounted two arms 21 arranged in the same diametric plane of the conveying roller 20 and at opposite ends of the conveying roller 20.

The number of arms 21 can differ from two, for example there can be one, three or more.

At the end of the two arms 21, further gripping devices 22 are arranged for gripping the sheet when it is released by the gripping devices 16 of the supporting roller 13. The sheet, after having been gripped by the further gripping devices 22, is conveyed towards the next printing unit. During transfer the sheet moves within a guide 23 provided with a surface 24 that is semi-cylindrical in shape. The surface 24 is provided with a plurality of holes, not shown in the Figure, out of which a continuous flow of air is blown. The sheets, supported by the flow of air, are conveyed within the guide 23 substantially without coming into contact with the surface 24.

As an alternative to the flow of air other systems can be used to prevent the conveyed sheet from sliding against the surface 24.

The sheet is thus brought into a position in which the gripping devices 16 of the next printing unit can grip it. Then the further gripping devices 22 release the sheet which has been gripped by the supporting roller of the next unit to perform the next printing phase.

The sheet is conveyed, as described above, in such a way that it successively passes through the first offset printing unit 10, the first conveying device 17, the second offset printing unit, the second conveying device 18, the third offset printing unit 12 and the third conveying device 18. Along such a path, three different inks are deposited on the sheet, one on top of another, or one next to another, to form part of the printed motif.

Subsequently the sheet, conveyed by the further gripping devices 22 of the third conveying device 19, is brought into a position such that it is gripped by the edge thereof by still further gripping devices 25.

The still further gripping devices 25 comprise pliers mounted on a counter cylinder 26, or on a supporting cylinder of the screen-printing unit 4.

The supporting cylinder 26, shown in greater detail in FIGS. 8-23, is arranged to convey the sheet and to provide a support for the sheet during the screen-printing phase.

As shown in FIG. 8, the supporting cylinder 26 is rotatable around a rotation axis that is not shown, that is perpendicular to the plane of the Figure, in the rotation direction F1. The supporting cylinder 26 comprises a supporting surface S on which there is rested a sheet 100 to be printed.

On the supporting surface S there are provided two housings 40, positioned on a same diametric plane of the supporting cylinder 26, each of which houses a gripper 25a of the still further gripping devices 25.

In an embodiment that is not shown, the housings provided on the supporting cylinder 26 may be different in number than two, for example one, three or four. The number of housings may depend on the dimensions of the supporting surface S of the supporting cylinder 26 and/or of the dimensions of the sheet 100 to be printed.

The housings 40 can be regularly spaced on the supporting surface S of the supporting cylinder 26.

Each gripper 25a comprises a body 41, housed in the housing 40, from which there projects a gripping appendage 42 that is shaped so as to form an edge zone 100a of the sheet 100 to be printed.

The body 41 is movable inside the housing 40 between a gripping position X, shown in FIGS. 8-23, in which the gripping appendage 42 abuts on the supporting surface S of the supporting cylinder 26, and a release position, which is not shown, in which the gripping appendage 42 is distanced from the supporting surface S. In the gripping position X, the gripping appendage 42 engages the edge zone 100a clamping it against the supporting surface S in such a way as to lock the sheet 100 against the supporting cylinder 26. In the release position, it is possible to introduce the sheet 100 onto the supporting cylinder 26, inserting it between the gripping appendage 42 and the supporting surface S. Similarly, in the release position it is possible to remove the sheet 100 from the supporting cylinder 26.

The supporting cylinder 26 has a plurality of sucking holes through which air is sucked in from the exterior to the interior of the supporting cylinder 26 in the direction indicated by the arrows F2, to improve the adhesion of the sheet 100 to the supporting surface S of the supporting cylinder 26.

In this way, it is possible to maintain the sheets 100 adhering to the supporting cylinder 26.

The sucking holes are suitably positioned on the supporting cylinder 26, in such a way as to affect a significant angular extent of the supporting surface S of the supporting cylinder 26.

In the illustrated embodiments, the sucking holes are positioned in such a way as to extend along the circumference arc defined between the two housings 40 with which supporting cylinder 26 is provided.

If there is provided a number of housings greater than two, the sucking holes can be positioned along the circumference arc identified between two consecutive housings.

The sucking holes facilitate uniform adhesion of the sheet 100 to the supporting surface S of the supporting cylinder 26. It is thus prevented that possible air bubbles remain trapped between the sheet 100 and the supporting surface S, or that undulations or creases form on the sheet 100. This enables printing quality to be improved.

Lastly, as the holes are arranged in such a way as to affect a significant angular extent of the supporting surface S of the supporting cylinder 26, the adhesion of a sheet of even significant dimensions is significantly improved and facilitated.

The sucking holes are particularly useful if the sheet 100 to be printed is made of a relatively stiff material that opposes a certain resistance to adhering to the supporting surface S.

The sucking holes is particularly useful even if the sheet 100 is very thin and made of very light material, i.e. if the weight of the material applied to the sheet 100 is comparable with or even greater than the weight of the sheet 100. In this case, in fact, the sheet 100 would tend to fold under the weight of the applied material. This would make it difficult to spread the sheet 100 on the supporting cylinder 26 in an even manner.

The number of sucking holes, and/or the dimensions of the single sucking holes, and/or the arrangement thereof in the supporting cylinder 26 can be suitably selected on the basis of specific production requirements.

The screen-printing unit 4 further comprises applying means 43 for applying a flowable material or a covering material 29 to desired zones of the sheet 100.

The applying means 43 comprises a rotating screen 27 shaped like a hollow cylinder, and distributing means 28 arranged within the screen 27 to pour and batch the liquid flowable material 29. The applying means 43 further comprises a doctor blade 30 positioned inside the screen 27.

The distributing means are movable so as to able to pour the flowable material 29 where necessary within the screen 27. The flowable material, which can be for example an ink or a transparent varnish, is deposited on the internal surface of the screen 27 as it rotates. Predetermined areas of the screen 27 are permeable to the flowable material 29. Furthermore, the doctor blade 30 is arranged inside the screen 27 to distribute the flowable material 29 along the axial direction of the screen 27 and to facilitate the passage of the flowable material 29 through the permeable areas of the screen 27. The inclination of the doctor blade 30 relative to the internal surface of the screen 27 with which it is contact and the pressure with which an active end 30a of the doctor blade 30 is pushed against the screen 27 can be varied according to the flowable material used and to the printing process is being performed.

Thanks to, the doctor blade 30, the flowable material 29 passes through the screen 27 and is deposited on the sheet below. The permeable areas are so arranged that the flowable material 29 is deposited on predetermined areas of the printed motif and is superposed on the inks already printed by the previous three offset printing units 10, 11 and 12.

In a version, the screen 27 can be provided with a permeable area whose extension is equal to the extension of the sheet, so that the latter is uniformly coated with the flowable material 29, which in this specific instance can be a liquid varnish.

Subsequently, during the rotation of the supporting cylinder 26 the sheet is conveyed to a position in which its edge is gripped by further gripping elements 31 mounted on chain means 32 or on further conveying rollers not shown in the Figure. The still further gripping devices 25 then release the sheet that is conveyed by the chain means 32 or by the further conveying rollers into the drying means 6.

The screen-printing unit 4 comprises a shifting device that is not shown in the Figures, that enables the applying means 43 to be shifted between an operating position Z in which the applying means 43 interacts with the sheets 100, and a disengagement position W in which the applying means 43 is distanced from the supporting cylinder 26.

The operating position Z is shown in FIGS. 8, 10, 12, 14, 16, 18, 20, 22, whilst the disengagement position W is shown in FIGS. 9, 11, 13, 15, 17, 19, 21, 23.

In the operating position Z, the applying means 43 is in contact with the sheet 100 to be printed for applying the flowable material 29 to desired zones of the sheet 100, whilst in the disengagement position W, the applying means 43 is shifted away from the supporting cylinder 26.

By acting on the shifting device, it is possible to make the applying means 43 shift near the sheet 100 and the supporting cylinder 26 for applying the flowable material 29, and make the applying means 43 shift away from the supporting cylinder 26 after the applying means 43 have applied the flowable material 29 to the sheet 100 to be printed.

The shifting device shifts the applying means 43 to the disengagement position W when the grippers 25a are near the screen 27. In this way, the grippers 25a can pass below the screen 27 without coming into contact with the latter. This enables damage to the screen 27 by the grippers 25a to be avoided.

In the embodiment in FIGS. 8 and 9, the shifting device comprises a translating device for translating the doctor blade 30 inside the screen 27 with respect to the supporting cylinder 26, as indicated by the arrow F3. In this embodiment, in the operating position Z, the doctor blade 30 is pushed against the internal surface of the screen 27, in such a way that the active end 30a of the doctor blade 30 deforms the screen 27. In this position there is generated a sort of cusp in the screen 27 at a contact zone 44 between the screen 27 and the supporting cylinder 26. furthermore, in the operating position Z, the active end 30a of the doctor blade 30 forms with the internal surface of the screen 27 a working angle α1.

The flowable material 29 is applied to the sheet 100 at the contact zone 44. The contact zone 44 has a very limited, almost punctiform extent, which enables the flowable material 29 to be applied to the sheet 100 with great precision.

In the disengagement position W, the surface of the screen 27 and the supporting surface S of the supporting cylinder 26 are spaced, i.e. they are at a distance d1 from one another, that is such as to enable the grippers 25a to be moved below the screen 27 without interfering therewith and therefore without damaging it.

In the disengagement position W, the active end 30a of the doctor blade 30 forms with the internal surface of the screen 27 a disengagement angle α2 having an extent that is greater than the extent of the working angle α1.

In the embodiment in FIGS. 10 and 11, the shifting device comprises a translation mechanism for translating the applying means 43, i.e. the screen 27 and the doctor blade 30, with respect to the supporting cylinder 26, as indicated by the arrow F4.

In this embodiment, the doctor blade 30 is pushed against the internal surface of the screen 27, in such a way that the active end 30a deforms the internal surface of the screen 27, forming a cusp, both in the disengagement position W and in the operating position Z.

In this case, both in the operating position Z and in the disengagement position W, the active end 30a forms with the internal surface of the screen 27 a working angle α1.

In the operating position Z, the applying means 43 is pushed by the translation mechanism against the supporting cylinder 26 at the contact zone 44, in which the flowable material 29 is applied to the sheet 100.

Also in this case, the contact zone 44 has a very limited, almost punctiform, extent, which enables the flowable material 29 to be applied to the sheet 100 with great precision.

In the disengagement position W, the surface of the screen 27 and the supporting surface S of the supporting cylinder 26 are spaced by a distance d1 that is such as to enable the grippers 25a to pass below the screen 27 without damaging it.

In the embodiment in FIGS. 12 and 13, the shifting device comprises a rotating device for rotating the doctor blade 30 inside the screen 27, as shown by the arrow F5.

The doctor blade 30 is positioned in an eccentric manner with respect to the screen 27, i.e. it is rotatable around an axis that is distinct from the longitudinal axis of the screen 27. In this way, the rotation of the doctor blade 30 causes a deformation of the screen 27, as indicated below. In the operating position Z, the doctor blade 30 is pushed against the internal surface of the screen 27 in such a way as to deform it and to generate a cusp. In the disengagement position W, the doctor blade 30 is positioned inside the screen 27 without deforming it.

Owing to the rotating device, the doctor blade 30 can alternatively take the screen 27 in contact with the sheet 100 on the supporting cylinder 26, for applying the flowable, material 29, as shown in FIG. 12, and moving the screen 27 away from the supporting cylinder 26 by the distance d1, so that the gripper 25a does not damage the screen 27, as shown in FIG. 13.

In the operating position Z, the active end 30a of the doctor blade 30 forms with the internal surface of the screen 27 a working angle α1. In the disengagement position W, on the other hand, the end portion 30a of the doctor blade 30 forms with the internal surface of the screen 27 a disengagement angle α2 that is greater than the working angle α1.

In the embodiment in FIGS. 14 and 15, the shifting device comprises a rotating mechanism for rotating the applying means 43, i.e. the whole comprising the screen 27 and the doctor blade 30, as indicated by the arrow F6. The applying means 43 is rotated around an axis parallel to, or coinciding with, the rotation axis of the screen 27.

In the embodiment in FIGS. 14 and 15, the doctor blade 30 is pushed against the internal surface of the screen 27, in such a way that the active end 30a deforms the internal surface of the screen 27, forming a cusp, both in the operating position Z and in the disengagement position W.

The rotating mechanism enables the applying means 43 to be placed alternatively in contact with the sheet 100, for applying the flowable material 29, and the applying means 43 to be moved away from the supporting cylinder 26 by a distance d1 to prevent the grippers 25a interfering with the screen 27.

In the embodiments of FIG. 16-23 there is shown applying means 43 provided with a shifting device corresponding respectively to the embodiments of the shifting device shown in FIGS. 8-15. The corresponding parts are therefore shown by the same numerical references and are not disclosed in detail.

In these embodiments, the sheets 100 are moved through the screen-printing unit 4 by a conveying device 45 that is movable along a loop path and that conveys the sheets 100 to be printed along the advancing direction F.

The conveying device 45 may possibly extend as far as the drying means 6, conveying the sheets 100 along the advancing direction F from the third offset printing unit 12 through the screen-printing unit 4 as far as the drying means 6.

The conveying device 45 may comprise a moving chain 46 wound on a pair of wheels that are not shown.

Possibly, one or more chain moving devices can be provided for moving the sheets 100 also through the offset printing units 10, 11 and 12.

In an alternative embodiment, the moving means 5 may comprise a single chain moving device shaped in such a way as to extend at least between the offset printing units 10, 11, 12 and the screen-printing unit 4, or even until the drying means 6, to move the sheets 100 along the advancing direction F.

The conveying device 45 cooperates at least at the screen-printing unit 4, with the supporting cylinder 26, acting as a support for the sheet 100 to be printed, as better explained below.

The moving chain 46 comprises a further supporting surface S1, positioned on the side facing the applying means 43, on which the sheet 100 to be printed is received.

The moving chain 46 is further provided with seats that are not shown and that are arranged for receiving grippers 47 comprising a member 48, from which there protrudes a gripping end 49 arranged for grasping an edge zone 100a of the sheet 100 to be printed.

The grippers 47 are shaped like the still further gripping elements 25 and are movable inside the respective seats between a gripping position X, shown in FIGS. 16-23, in which the gripping end 49 engages the edge portion 100a of the sheet 100 making it abut on the further supporting surface S1 of the moving chain 46, and a release position, which is not shown, in which the gripping end 49 is distanced from the further supporting surface S1.

The sheet 100 leaving the third offset printing unit 12 is grasped by the grippers 47 and moved by the moving chain 46 to the screen-printing unit 4. At the screen-printing unit 4 the moving chain 46 is interposed between the applying means 43 and the supporting cylinder 26.

The moving chain 46 rests on the supporting cylinder 26, at the application zone 44. This enables the sheets 100 to be supported better near the applying means 43, so as to ensure, that the flowable material 29 is applied precisely.

In the embodiments comprising the moving chain 46, the supporting cylinder 26 can be provided with housings 40 but without grippers 25a.

Also in these embodiments, the supporting cylinder 26 can be provided with a plurality of sucking holes to promote the adhesion of the sheet 100 to the moving chain 46 and to improve the application of the flowable material 29. In this case, the moving chain 46 is shaped in such a way as to enable the passage through it of the air sucked from the holes of the supporting cylinder 26.

The shifting devices provided in the embodiments of FIG. 16-23 enable the applying means 43 to be shifted with respect to the supporting cylinder 26 and to the moving chain 46, to prevent the grippers 47 damaging the screen 27, as explained previously.

In particular, in the embodiment in FIGS. 16 and 17, the doctor blade 30 can be moved along a rectilinear trajectory towards or away from the supporting cylinder 26.

In the embodiment in FIGS. 18 and 19, the whole comprising the screen 27 and the doctor blade 30 is movable along a rectilinear trajectory.

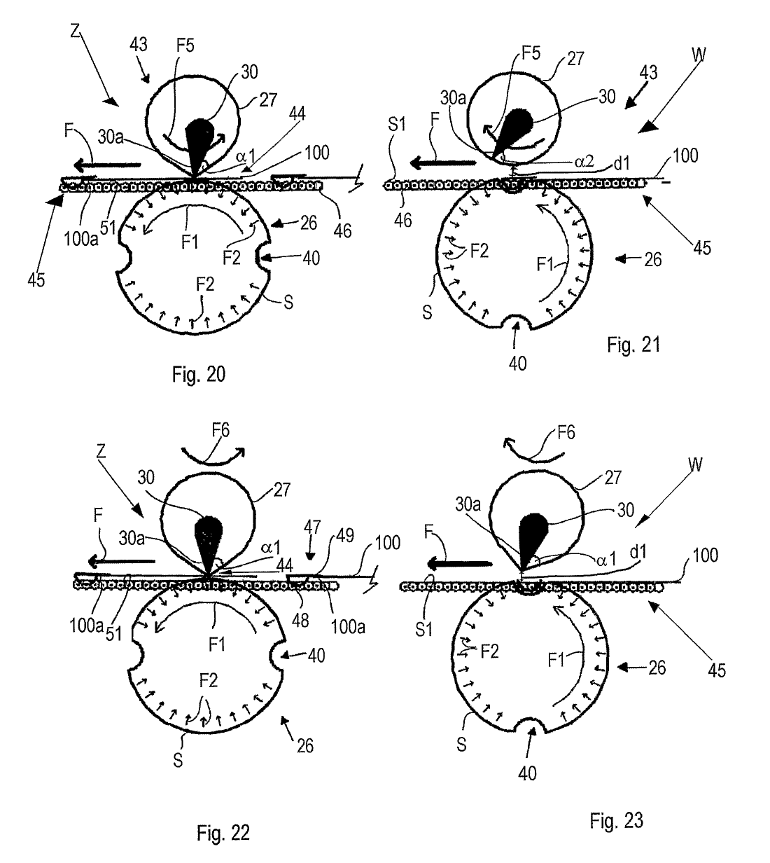

In the embodiment in FIGS. 20 and 21, the doctor blade 30 is rotatable around a rotation axis arranged eccentrically inside the screen 27.

Lastly, in the embodiment in FIGS. 22 and 23, the whole formed by the doctor blade 30 and by the screen 27 is rotatable around a common rotation axis.

The apparatus 1 may further comprise electronic coupling devices for electronically coupling the supporting cylinder 26 and/or the moving chain 46 with the applying means 43 of the screen-printing unit 4, in such a way as to adjust the application of the flowable material 29, as better explained below.

The electronic coupling devices are connected to adjusting devices that enable the rotation speed of the supporting cylinder 26 and/or the translation speed of the moving chain 46, and/or the rotation speed of the screen 27 to be adjusted by increasing or decreasing the rotation speed in order to enable the flowable material 29 to be suitably applied.

Usually, the values of the aforesaid speeds are set during the design phase and are such that in the screen-printing unit 4 a desired quantity of flowable material 29 is deposited on the sheet 100, and that the flowable material 29 is deposited according to a desired pattern defined by a drawing matrix.

However, if the sheet 100 is subjected to dimensional variations due, for example, to considerable variations in temperature, humidity, etc., if the apparatus operates at preset speed values, poor print quality is obtained.

Drawings should be also obtained on non expected zones of the sheet 100, or also drawings should be obtained that are not centred on the sheet 100.

The step of applying the covering material 29 could start before a sheet is conveyed to the application zone, or the application step could start later than provided.

In order to adapt the operation of the screen-printing unit 4 to dimensional variations in the sheet 100, in the prior art it is necessary to vary the drawing matrix in such a way as to obtain the desired drawing on the sheet 100.

This entails significant expense, and slows down the apparatuses.

The electronic coupling devices enable the actual position of the sheet 100 on the supporting cylinder 26 or on the moving chain 46 and the actual dimensions of the sheet 100 to be recorded, and the rotation speed of the supporting cylinder 26 and/or the translation speed of the moving chain 46, and/or the rotation speed of the screen 27 to be accordingly adjusted in such a way as to obtain the desired pattern on the sheet 100.

The electronic coupling devices may comprise a first sensor for recording the position of the advanced edge 100a of the sheet 100, a second sensor can record the position of the opposite edge of the sheet 100.

These recordings can be processed by a processing system that, through adjusting devices, suitably adjust the rotation speed of the supporting cylinder 26 and/or the translation speed of the moving chain 46, and/or the rotation speed of the screen 27.

In this way, it is possible to begin the applying step for applying the flowable material 29 only when the desired portion of the sheet 100 is positioned in the contact zone 44.

It is further possible, by increasing or decreasing the involved speeds, to adjust the actual dimensions of the printed pattern on the basis of the actual dimensions of the sheet 100.

It is, thus, possible to obtain high print quality also in cases of dimensional variations to the sheets to be printed without having to redo the drawing matrix.

A very cheap printing process is thus obtained that is at the same time efficient and of high quality.

The apparatus 1 may further comprise electronic coupling devices arranged for electronically coupling the supporting roller 13 and the transferring roller 15 to adjust the application of the inks in the offset printing units 10, 11, 12.

The apparatus 1 further comprises drying means 6 comprising a tunnel 33 inside which a plurality of drying elements 34 are arranged. The drying elements drying 34 are arranged to face the sheets when the latter are conveyed through the tunnel 33. The drying elements 34 make it possible to dry the inks and the coating material deposited on the sheet and are of different types in relation to the type of inks and coating materials used in the printing process. For example UV or IR dryers or jets of hot air can be used.

At the exit of the tunnel 33, completed prints are obtained which are released by the further gripping elements gripping 31 and deposited in further piles of sheets.

The further piles of sheets, not shown in FIG. 1, are ready to be collected from the printing apparatus 1.

FIG. 2 shows a printing apparatus 101, according to a further embodiment of the printing apparatus 1.

The components of the printing apparatus 101 in common with those of the printing apparatus 1 will not be described in detail again and will be indicated by the same reference numbers already used in FIG. 1.

The printing apparatus 101 differs from the apparatus 1 because the screen-printing unit is arranged inside the tunnel 33. In this case, the screen-printing phase takes place immediately before the sheets are conveyed into the proximity of the drying elements 34.

Both in the apparatus 1 and in the apparatus 101 there may be intermediate drying elements 35 to facilitate drying of the inks deposited on the sheets by the offset printing units.

The intermediate drying devices 35 are arranged in the proximity of the supporting rollers 13 and face the latter so that the sheets pass before them after the ink has been deposited by the transferring rollers 15.

The intermediate drying devices 35 are useful when inks that dry with difficulty are used.

FIG. 3 shows a section of a sheet printed by the apparatus 1 shown in FIG. 1 or by the apparatus 101 shown in FIG. 2. This section shows a sheet 60 on which a first layer of colour 61a has been deposited by a first printing process carried out in the first offset printing unit 10, a second layer of colour 61b by a second printing process carried out in the second offset printing unit 11, a third layer of colour 61c by a third printing process carried out in the third offset printing unit 12 and a layer of coating material 29 deposited during the screen-printing phase.

In the example in FIG. 3, the coating material 29 has been applied only in desired predetermined areas of the sheet 60. This happens when, for example, it is desired to render shiny certain particulars of the motif printed by applying a transparent varnish. It is however possible to apply the coating material 29 uniformly all over the sheet 60.

The apparatus 1 and the apparatus 101 carry out a high quality printing process in a different way from known printing machines where the coating material is applied within a flexographic printing unit. In fact the coating material 29 deposited on the sheet by the screen-printing process creates a layer with a very smooth and regular surface. Furthermore the layer of ink or of transparent varnish deposited by the screen-printing process is free of unevenness. In this way, the print obtained does not have an undulated surface, thus satisfying high quality requirements.

Use of the apparatus 1 or the apparatus 101 further makes it possible to combine the high productivity typical of known offset printing machines, with the high quality production of screen printing.

The screen-printing unit provided in the apparatus makes it possible further to deposit layers of coating material of a greater thickness that those obtainable using the other typographical processes.

This makes it possible to obtain, at the outfeed of apparatus 1 or 101, a sheet bearing not only a printed motif, but also a piece of text in Braille characters without the need for further work, such as for example Braille punching operations.

Thus the need to convey the printed sheets to a separate Braille punching machine to produce the Braille characters is eliminated. This entails a saving both in terms of production costs and times.

For this particular application special varnishes can be used which make it possible to obtain Braille characters that are at least as resistant to abrasion and wear as those obtained using known methods.

In addition, the great thickness of coating material that can be applied using screen-printing makes it possible to obtain prints with very good chemical and physical resistance, which maintain their characteristics over time. In fact repeated exposure over time to light or to atmospheric agents can ruin the quality of the printed motifs, for example fading the colours. The screen-printing procedure can produce motifs endowed with a valid protection against light and atmospheric agents, for example by using transparent protective varnishes as coating material or by just depositing very thick layers of ink.

The great thickness of coating material that can be applied using screen-printing is useful also when it is necessary to deposit a layer in a light colour over an already deposited layer in a dark colour. This prevents the forming of unwanted transparencies and prevents alterations to the chromatic characteristics of the motif which is being reproduced. For this reason, screen-printing also makes it possible to print in the best manner possible a layer in a light colour over a layer in a dark colour.

Furthermore, during the screen-printing process the ink is not squeezed between two rigid rollers rotating in contact with each other and thus it does not undergo extreme treatments. In particular, the ink passes through the permeable areas of the screen without being subjected to high printing pressures. In contrast, with offset or flexographic printing units the ink is compressed, by the rollers it comes into contact with, every time the ink is transferred from one roller to another roller or when it is transferred to the sheet.

Thus the screen-printing unit makes it possible to print motifs obtained with special coating materials or inks that would deteriorate if subjected to high pressures. The special coating materials or inks can include inks that are used for printing advertising materials and include microcapsules containing perfumed substances. The microcapsules are predisposed to break, freeing the perfumed substances, when a user touches the printed motif, for example with a hand. High pressures during the printing phase would break the microcapsules at an inopportune time, freeing the perfumed substances during the printing phase and making the utilisation of the special ink useless.

Using the screen-printing unit it is also possible to easily print motifs obtained with special colorants, which, if used in offset or flexographic printing units, deteriorate the rollers of such units.

The special colorants can include, for example, inks containing small solid particles in suspension, suitable for providing a metallic finish effect.

Such particles are harder than the moving parts involved in the printing process. Consequently, in offset or flexographic printing units, as the ink is transferred from one roller to another roller or it is transferred to the sheet, the solid particles, compressed by the rollers, scratch them. This can for example damage the printing plate arranged on the surface of the applying cylinder 14, altering the extension and the form of the ink-repelling areas and of the printing area on which the ink can be deposited.

In this way, the part of the motif to be printed by the offset printing unit in question is altered and the printing quality is reduced. To restore the desired printing quality it is then necessary to replace the damaged rollers, with a consequent increase in production costs. This does not happen, for the reasons already explained above, with the screen-printing unit of the invention.

FIG. 4 shows a printing apparatus 201, according to a still further version of the printing apparatus 1.

The components of the printing apparatus 201 that are in common with the printing apparatus 1 will not be described again in detail and they will be indicated using the same reference numbers as those already used in FIG. 1.

The printing apparatus 201 differs from the apparatus 1 because a plasticizing unit 202 is interposed between the third offset printing unit 12 and the screen-printing unit 4. In the plasticizing unit 202, which the sheet goes through after having already received part of the printed motif and having been conveyed by the third conveying devices 19, a layer of transparent plastic material 62, shown in FIG. 5, is applied to the sheet. For this reason, the plasticizing unit 202, shown in greater detail in FIG. 24, comprises supply means 203, the structure of which is not shown in FIG. 4, which supply a plastic film 204 to a depositing roller 205 which rotates in contact with a supporting roller 206. The depositing roller 205 deposits the plastic film 204 on the sheet while this is transported by the supporting roller 206. The plastic film 204 adheres in a removable manner to a substrate 204a and is initially wound around a core so as to form a reel 204b that is unwound from the supply means 203 in the direction indicated by the arrow F7, to supply the plastic film 204 to the depositing roller 205.

The depositing roller 205 is rotatable in the direction of the arrow F8, in a direction opposite the rotation direction F1 of the supporting roller 206.

The depositing roller 205 is positioned in such a way as to be in contact with the sheet 100 to press the plastic film 204 onto the sheet 100.

In this way, during the rotation of the depositing roller 205 and of the supporting roller 206, the plastic film 204 is applied to the sheet 100.

The plastic film 204 may comprise pre-cut portions 214 anchored to the substrate 204a.

In an alternative embodiment, there can be provided, at the depositing roller 205, cutting means for cutting the plastic film 204 in such a way as to obtain therefrom portions having the dimensions of the sheet 100′, or of the portion of the sheet 100, on which the plastic film 204 has to be deposited.

After the plastic film 204 has been deposited on the sheet 100, the substrate 204a is moved along the direction indicated by the arrow F9 to be wound on an exhausted reel 204c using suitable winding means that is not shown. To fix the plastic film 204 to the sheet 100, a surface of the plastic film 204 predisposed to come into contact with the sheet is adhesive and/or the depositing roller 205 can be heated. In this manner the motif, already partially printed on the sheet, is provided with a protective layer. With this aim, over the layers of colour 61a, 61b and 63b already deposited on the sheet, the layer of plastic material 62 is superimposed, as shown in FIG. 5.

Coating the motif with a layer of plastic material increases the chemical and physical resistance of the print and makes it possible to obtain products that maintain their characteristics over time.

Subsequently the discrete sheet coated with the layer of plastic material 62, once it has gone through the plasticizing unit 202, is released by the supporting roller 206 to a fourth conveying device 207 which is completely analogous, in function and structure, to the conveying devices 17, 18, and 19 already mentioned in the description of the apparatus 1. The fourth conveying device 207 grips an edge of the sheet thanks to further gripping devices 208 and conveys the sheet until it reaches a position in which the still further gripping devices 25 mounted on the supporting cylinder 26 of the screen-printing unit 4 grip its edge. The sheet then goes through the screen-printing unit 4 and the coating material 29 is deposited over the layer of plastic material 62. Thanks to the apparatus 201 it is possible to obtain prints provided with a three-dimensional effect due to the presence of a coloured layer, formed by the coating material 29, arranged over a transparent layer, formed by the plastic film 204, and distanced from the other layers of colour deposited on the sheet.

The apparatus 201 makes it possible to obtain the three-dimensional effect described above using a single printing apparatus thus eliminating the transporting of semi-finished sheets from an offset printing machine to a separate plasticizing machine. This results in a saving both in terms of costs and times of production.

In an embodiment that is not shown, in the printing apparatus 301 provided with the plasticizing unit 202 the screen-printing unit can be lacking, should there be no desire to apply the coating material 29 to the sheet using screen-printing techniques.

FIG. 6 shows a printing apparatus 301, according to a further embodiment of the printing apparatus 1.

The components of the printing apparatus 101 that are in common with the printing apparatus 1 will not be described again in detail and will be denoted by the reference numbers already used in FIG. 1.

The printing apparatus 301 differs from the apparatus 1 because an inkjet printing unit 302 is interposed between the third offset printing unit 12 and the screen-printing unit 4. The inkjet printing unit 302 can print lettering or serial numbering on sheets bearing a printed motif that has already been completed by the three offset printing units 10, 11 and 12.

For example, in limited-edition production of artistic prints, use is made of the printing of lettering or serial numbering.

The inkjet printing unit 302 comprises supplying means 303 arranged to supply printing head means 304 with ink. The printing head means 304 are arranged to spray the colour onto the sheet while the latter is being conveyed by a supporting roller 305. The sheet, once it has passed through the inkjet printing unit 302, is released by the supporting roller 305 to a fourth conveying device 306, completely alike in function and structure to the conveying devices 17, 18 and 19 already mentioned in the description of the apparatus 1. The fourth conveying device 306 grips an edge of the sheet thanks to further gripping devices 307 and conveys the sheet to a position in which the still further gripping devices 25 mounted on the supporting cylinder 26 of the screen-printing unit 4 grip its edge. The sheet then passes through the screen-printing unit 4 which applies to it the coating material 29 which, in this version of the apparatus, is a transparent varnish. This transparent varnish covers the area of the sheet where the lettering or serial number has been printed. In this manner the screen-printing unit 4 adds anti-forgery means to the print produced by the apparatus 401. In fact, as shown in FIG. 7, the area of the sheet where the lettering or the serial number have been printed, forming an interrupted layer of ink 63, is coated with a layer of transparent varnish 64, deposited by the screen-printing unit 4 and preventing their removal.

The screen-printing unit furthermore makes it possible to deposit layers of transparent varnish 64 of a greater thickness than can be obtained with other typographical processes and this makes the anti-forgery means more effective that any obtainable with other typographical processes.

In other embodiments of the apparatus 301, not shown in the Figures, the inkjet printing unit 302 can be positioned, according to requirements, in different positions from those described above or in combination with the plasticizing unit.

In FIGS. 1, 2, 4 and 5, the screen 27 has always been shown as being cylindrical in shape. It is however possible to use, in the screen-printing unit 4, screens having a substantially flat form.

1. Printing apparatus for printing discrete sheets, comprising a plurality of offset printing units arranged in sequence along an advancing direction of said discrete sheets, at least a screen-printing unit including supporting means for supporting said discrete sheets and applying means for applying a flowable material to said discrete sheets, said applying means comprising a screen and doctor means interacting with said screen for applying said flowable material to said discrete sheets, said at least a screen-printing unit comprising a shifting device for shifting said applying means between an operating position in which said applying means interacts with said discrete sheets, and a disengagement position in which said applying means is distanced from said supporting means, said doctor means comprising a blade which deforms said screen in said operating position so that said screen contacts said discrete sheets.

2. Printing apparatus according to claim 1, wherein said shifting device comprises a translating device for translating said applying means with respect to said supporting means.

3. Printing apparatus according to claim 2, wherein said translating device is connected to said doctor means to move said doctor means with respect to said screen.

4. Printing apparatus according to claim 2, wherein said translating device is connected to said doctor means and to said screen to move said doctor means and said screen with respect to said supporting means.

5. Printing apparatus according to claim 1, wherein said shifting device comprises a rotating device for rotating said applying means with respect to said supporting means.

6. Printing apparatus according to claim 5, wherein said rotating device is shaped in such a way as to rotate said doctor means with respect to said screen.

7. Printing apparatus according to claim 6, wherein said doctor means is rotatable around a rotation axis that is distinct from a longitudinal axis of said screen.

8. Printing apparatus according to claim 5, wherein said rotating device is shaped in such a way as to rotate said doctor means and said screen around a common rotation axis.

9. Printing apparatus according to claim 1, wherein said at least a screen-printing unit is arranged downstream of said plurality of offset printing units with respect to said advancing direction.

10. Printing apparatus according to claim 1, wherein said at least a screen-printing unit is arranged between a first offset printing units and a second offset printing units of said plurality of offset printing units.

11. Printing apparatus according to claim 1, and further comprising drying means arranged downstream of said plurality of offset printing units with respect to said advancing direction.

12. Printing apparatus according to claim 11, wherein said at least a screen-printing unit is arranged upstream of said drying means with respect to said advancing direction.

13. Printing apparatus according to claim 11, wherein said drying means comprises said screen-printing unit.

14. Printing apparatus according to claim 1, and further comprising an ink-jet printing unit, wherein said at least a screen-printing unit is arranged downstream of said ink-jet printing unit with respect to said advancing direction.

15. Printing apparatus according to claim 14, wherein said ink-jet printing unit comprises numbering means for printing a consecutive number on said discrete sheets.

16. Printing apparatus according to claim 1, wherein said supporting means comprises housing means arranged for housing gripping devices for grasping an edge portion of said discrete sheets.

17. Printing apparatus according to claim 1, wherein said supporting means comprises a supporting cylinder for supporting a sheet of said discrete sheets at least in said screen-printing unit.

18. Printing apparatus according to claim 17, wherein said supporting cylinder comprises sucking means distributed along a significant angular extent of said supporting cylinder for maintaining said discrete sheets adhering to said supporting cylinder.

19. Printing apparatus according to claim 18, wherein said supporting means comprises a supporting cylinder for supporting a sheet of said discrete sheets at least in said screen-printing unit and wherein said sucking means is distributed along an external surface portion of said supporting cylinder, said portion being defined between two consecutive housings of said housing means.

20. Printing apparatus according to claim 18 wherein said sucking means comprises a plurality of sucking holes.

21. Printing apparatus according to claim 1, wherein said supporting means comprises conveying means that is movable along a loop path for supporting a sheet of said discrete sheets at least in said screen-printing unit.

22. Printing apparatus according to claim 21, wherein said conveying means comprises chain means.

23. Printing apparatus according to claim 21, wherein said supporting means comprises a supporting cylinder for supporting a sheet of said discrete sheets at least in said screen-printing unit and wherein said conveying means (45, 46) is interposed between said applying means (43) and said supporting cylinder (26).

24. Printing apparatus according to claim 1, and comprising an electronic coupling device for electronically coupling said supporting means to said applying means to adjust the application of said flowable material.

25. Printing apparatus according to claim 24, wherein said electronic coupling device is programmed in such a way as to adjust the moving speed of said supporting means.

26. Printing apparatus according to claim 24 wherein said electronic coupling device is programmed in such a way as to adjust the moving speed of said applying means.

27. Printing apparatus according to claim 1, wherein said screen is substantially cylindrical.

28. Printing apparatus according to claim 1, wherein said screen is substantially flat.

29. Printing apparatus according to claim 1, wherein said screen-printing unit comprises printing means for printing braille characters on said discrete sheets.

30. Printing apparatus according to claim 1, and further comprising a plasticizing unit for applying a film of plastics to said discrete sheets.

31. Printing apparatus according to claim 30, wherein said at least a screen-printing unit is arranged downstream of said plasticizing unit with respect to said advancing direction.

32. Printing apparatus according to claim 30 wherein said plasticizing unit comprises an applying device for applying said film of plastics to said discrete sheets.

33. Printing apparatus according to claim 32, wherein said applying device comprises separating means for separating said film of plastics from a supporting substrate to which said film of plastics initially adheres.

34. Printing apparatus according to claim 32 wherein said plasticizing unit comprises an unwinding device for unwinding said film of plastics from a reel and supplying said film of plastics to said applying device.

35. Printing apparatus according to claim 33, and further comprising collecting means for collecting said supporting substrate.

36. Printing apparatus according to claim 35, wherein said collecting means comprises a winding device for winding said supporting substrate so as to form an exhausted reel of said supporting substrate.

37. Printing apparatus according to claim 30, and further comprising a cutting device for cutting from said film of plastics portions of said film of plastics having desired dimensions that are suitable for being applied to one discrete sheet of said discrete sheets.

38-89. (canceled)
